(19) United States
(12) Patent Application Publication
(10) Pub. No.: US 2021/0373138 A1
(43) Pub. Date: Dec. 2, 2021

(54) DYNAMIC LIDAR ALIGNMENT

(71) Applicant: GM GLOBAL TECHNOLOGY OPERATIONS LLC, Detroit, MI (US)

(72) Inventors: Shengbing Jiang, Rochester Hills, MI (US); Yao Hu, Sterling Heights, MI (US); Xinyu Du, Oakland Township, MI (US); Wen-Chiao Lin, Rochester Hills, MI (US); Hao Yu, Troy, MI (US); Shiming Duan, Ann Arbor, MI (US)

(73) Assignee: GM GLOBAL TECHNOLOGY OPERATIONS LLC, Detroit, MI (US)

(21) Appl. No.: 16/887,397

(22) Filed: May 29, 2020

(51) Int. Cl. G01S 7/497; G01S 17/931; B60W 50/00; B60W 60/00

(52) U.S. Cl. CPC G01S 7/4972; G01S 17/931; B60W 2420/52; B60W 60/00; B60W 2050/0083; B60W 50/00

(57) ABSTRACT

Systems and method are provided for controlling a vehicle. In one embodiment, a method includes: recording, by a controller onboard the vehicle, lidar data from the lidar device while the vehicle is travelling on a straight road; determining, by the controller, that the vehicle is travelling straight on the straight road; detecting, by the controller, straight lane marks on the straight road; computing, by the controller, lidar boresight parameters based on the straight lane marks; calibrating, by the controller, the lidar device based on the lidar boresight parameters; and controlling, by the controller, the vehicle based on data from the calibrated lidar device.

### TECHNICAL FIELD

The present disclosure generally relates to lidar systems, and more particularly relates to systems and methods for lidars of a vehicle.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While autonomous vehicles and semi-autonomous vehicles offer many potential advantages over traditional vehicles, in certain circumstances it may be desirable for improved operation of the vehicles. For example, lidars need to be aligned re-aligned with the vehicle from time to time due to shifts caused by various driving conditions. Lidar alignment can be performed using data obtained from a fixed target and a fixed route. In some instance it can be difficult to frequently obtain such data for lidar re-alignment.

Accordingly, it is desirable to provide improved systems and methods for aligning sensors such as lidars of a vehicle. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a vehicle. In one embodiment, a method includes: recording, by a controller onboard the vehicle, lidar data from the lidar device while the vehicle is travelling on a straight road; determining, by the controller, that the vehicle is travelling straight on the straight road; detecting, by the controller, straight lane marks on the straight road; computing, by the controller, lidar boresight parameters based on the straight lane marks; calibrating, by the controller, the lidar device based on the lidar boresight parameters; and controlling, by the controller, the vehicle based on data from the calibrated lidar device.

In various embodiments, the determining that the vehicle is travelling on the straight line is based on lateral drift of the vehicle.

In various embodiments, the determining that the vehicle is travelling on a straight line is based on global positioning data.

In various embodiments, the detecting straight lane marks is based on extracting ground points and lane mark points from the lidar data.

In various embodiments, the computing the lidar boresight parameters is based on principal component analysis.

In various embodiments, the computing the lidar boresight parameters includes rebalancing, by the controller, lidar point distributions; computing, by the controller second and third principal component parameters for the left and right marks; and calibrating, by the controller, the boresight parameters.

In various embodiments, the method includes determining, by the controller, that reference lane marks exist with earth coordinates; and updating, by the controller, the lidar boresight parameters based on the reference lane marks.

In various embodiments, the method includes computing, by the controller, the lidar boresight parameters based on different vehicle locations.

In various embodiments, the computing the lidar boresight parameters includes performing integration with multiple lidar boresight parameters.

In various embodiments, the method includes determining, by the controller, that the vehicle is travelling on a flat road; and wherein the detecting the straight lane marks is based on the vehicle travelling on the flat road.

In another embodiment, a vehicle system of a vehicle is provided. The vehicle system includes: a lidar device; and a controller configured to, by a processor, record lidar data from the lidar device while the vehicle is travelling on a straight road, determine that the vehicle is travelling straight on the straight road, detect straight lane marks on the straight road, compute lidar boresight parameters based on the straight lane marks, calibrate the lidar device based on the lidar boresight parameters, and control the vehicle based on data from the calibrated lidar device.

In various embodiments, the controller is configured to determine that the vehicle is travelling on the straight line based on lateral drift of the vehicle.

In various embodiments, the method includes the controller is configured to determine that the vehicle is travelling on the straight line based on global positioning data.

In various embodiments, the controller is configured to detect straight lane marks based on extracting ground points and lane mark points from the lidar data.

In various embodiments, the controller is configured to compute the lidar boresight parameters based on principal component analysis.

In various embodiments, the controller is configured to compute the lidar boresight parameters by rebalancing, by the controller, lidar point distributions; computing, by the controller second and third principal component parameters for the left and right marks; and calibrating, by the controller, the boresight parameters.

In various embodiments, the controller is further configured to: determine that reference lane marks exist with earth coordinates; and update the lidar boresight parameters based on the reference lane marks.

In various embodiments, the controller is further configured to: compute the lidar boresight parameters based on different vehicle locations.

In various embodiments, the controller is further configured to compute the lidar boresight parameters by performing integration with multiple lidar boresight parameters.

In various embodiments, the controller is further configured to: determine the vehicle is travelling on a flat road and detect the straight lane marks based on the vehicle travelling on the flat road.

In another embodiment, a method of controlling a vehicle having a lidar device and an inertial measurement unit (IMU) includes: determining, by a controller, that the vehicle is performing a cornering maneuver based on recorded lidar data and IMU data; detecting, by the controller, objects in the lidar data; determining, by the controller, useful data associated with the detected objects from the lidar data; computing, by the controller, parameters based on the useful data; calibrating, by the controller, the lidar device based on the parameters; and controlling, by the controller, the vehicle based on data from the calibrated lidar device.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a lidar alignment system, in accordance with various embodiments;

FIG. 2 is a schematic block diagram of an automated driving system (ADS) for a vehicle, in accordance with one or more exemplary embodiments;

FIG. 3 is a dataflow diagram of a control module of the lidar alignment system, in accordance with one or more exemplary embodiments;

FIGS. 4-10 are flowcharts illustrating lidar alignment methods based on straight line marks in accordance with one or more exemplary embodiments;

FIG. 11 is a dataflow diagram of a control module of the lidar alignment system, in accordance with one or more exemplary embodiments; and

FIGS. 12-21 are flowcharts illustrating lidar alignment methods based on cornering maneuvers in accordance with one or more exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

In one or more exemplary embodiments described herein, a vehicle capable of autonomous operation includes a number of different devices that generate data representative of a scene or environment in a vicinity of the vehicle from different perspectives. A sensing angle of a single sensor or multiple sensors may be altered in order to improve range and/or resolution of sensor data. In this regard, the augmented or enhanced data set may then be analyzed and utilized to determine commands for autonomously operating one or more actuators onboard the vehicle. In this manner, autonomous operation of the vehicle is influenced by the enhanced data sets.

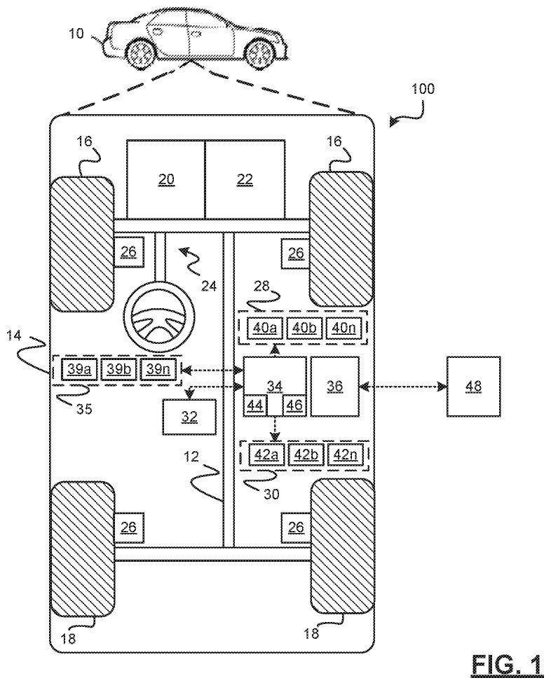

For example, as described in greater detail below in the context of FIGS. 1-10, in exemplary embodiments, a control system shown generally at 100 is associated with a vehicle 10 in accordance with various embodiments. In general, the control system 100 selectively aligns a sensor of the vehicle 10. In various embodiments, the control system 100 aligns a sensor such as a lidar using straight lane marks of a road.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the control system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. As can be appreciated, in various embodiments, the vehicle may be a non-autonomous vehicle and is not limited to the present examples.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors.

In various embodiments, the sensing devices 40a-40n are disposed at different locations of the vehicle 10. In exemplary embodiments described herein, the sensing devices 40-40n are realized as lidar devices. In this regard, each of the sensing devices 40a-40n may include or incorporate one or more lasers, scanning components, optical arrangements, photodetectors, and other components suitably configured to horizontally and rotatably scan the environment in the vicinity of the vehicle 10 with a particular angular frequency or rotational velocity.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

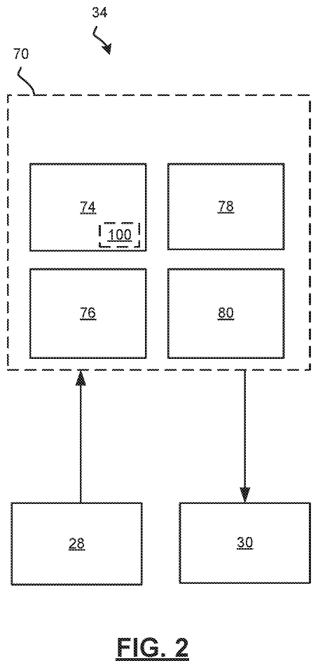

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. In various embodiments, the data storage device 32 stores calibrations for use in aligning the sensing devices 40a-40n. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In various embodiments, one or more instructions of the controller 34 are embodied in the control system 100 and, when executed by the processor 44, cause the processor 44 to perform the methods and systems that dynamically align the lidar devices by updating calibrations stored in the data storage device 32 as described in greater detail below.

Still referring to FIG. 1, in exemplary embodiments, the communication system 36 is configured to wirelessly communicate information to and from other entities 48, such as but not limited to, other vehicles (“V2V” communication) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In accordance with various embodiments, the controller 34 implements an autonomous driving system (ADS) 70 as shown in FIG. 2. That is, suitable software and/or hardware components of the controller 34 (e.g., processor 44 and computer-readable storage device 46) are utilized to provide an autonomous driving system 70 that is used in conjunction with vehicle 10, for example, to automatically control various actuators 30 onboard the vehicle 10 to thereby control vehicle acceleration, steering, and braking, respectively, without human intervention.

In various embodiments, the instructions of the autonomous driving system 70 may be organized by function or system. For example, as shown in FIG. 2, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors. In various embodiments, the computer vision system 74 receives information from and/or implements the control system 100 described herein.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

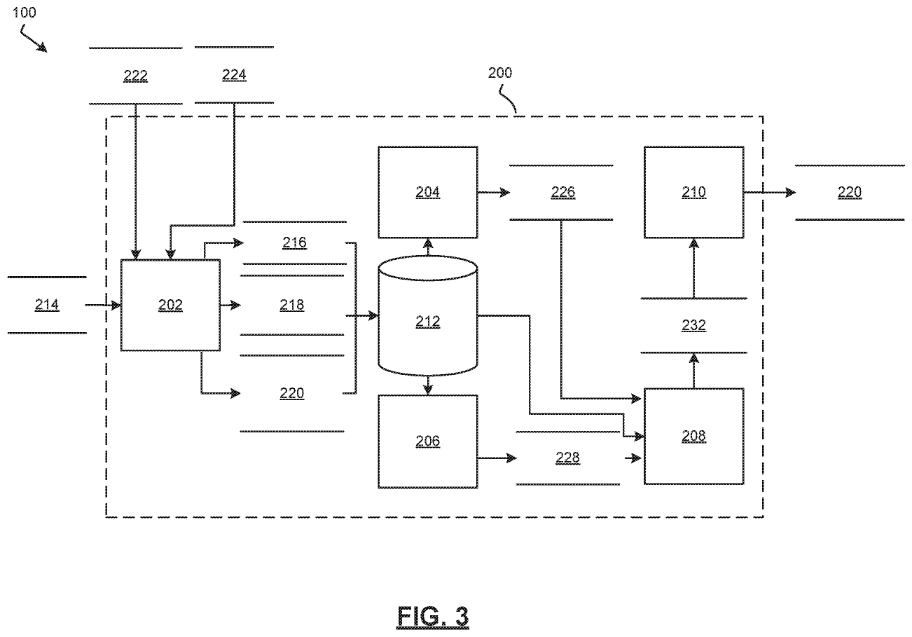

With reference now to FIG. 3 and with continued reference to FIGS. 1 and 2, FIG. 3 depicts an embodiment of a control module 200 of the control system 100 which may be implemented by or incorporated into the controller 34, the processor 44, and/or the computer vision system 74. In various embodiments, the control module 200 may be implemented as one or more sub-modules. As can be appreciated, the sub-modules shown and described may be combined and/or further partitioned in various embodiments. Data inputs to the control module 200 may be received directly from the sensing devices 40a-40n, received from other modules (not shown) of the controller 34, and/or received from other controllers (not shown). In various embodiments, the processing module 200 includes a data collection module 202, a vehicle travel evaluation module 204, a lane mark detection module 206, a parameter determination module 208, a calibration module 210, and a data datastore 212.

In various embodiments, the data collection module 202 receives as input recorded data 214. In various embodiments, the recorded data 214 includes lidar data 216, vehicle location data, 218 and vehicle orientation data 220 recorded over a predetermined time. For example, the data collection module 202 receives the recorded data 214 when history data 222 and/or map data 224 indicate that the vehicle 10 is or has recently travelled on a road that is deemed to be straight (e.g., labelled on a map as a straight road). The recorded data 214 that is received is associated with the travel of the vehicle 10 along the straight road. The data collection module 202 stores the recorded data 214 in the data datastore 212 for further processing.

In various embodiments, the vehicle travel evaluation module 204 receives the recorded data 214 and determines from the recorded data 214 whether the vehicle 10 is or was traveling straight on the straight road. For example, the vehicle travel evaluation module 204 evaluates the vehicle location data 218, for example as indicated by the GPS, to determine if the vehicle 10 is travelling straight and along a flat road. In various embodiments, the travel evaluation module 204 uses regression techniques to determine if the vehicle 10 is travelling straight.

When the vehicle 10 is determined to be travelling straight and along a flat road, the vehicle travel evaluation module 204 outputs a vehicle travel straight flag 226 indicating that the vehicle 10 is straight driving. When the vehicle 10 is determined to be not travelling straight or the vehicle 10 is determined to be not travelling along a flat road, the vehicle travel evaluation module 204 outputs a vehicle travel straight flag 226 indicating that the vehicle 10 is not straight driving.

In various embodiments, the lane mark detection module 206 receives the recorded data 214 and determines whether straight lane marks are detected on the road that the vehicle 10 is travelling. For example, the lane mark detection module 206 evaluates the lidar data 214, for example as indicated by the lidar device, to detect lane marks and determine if the detected lane marks are straight. In various embodiments, the lane mark detection module 206 uses image processing techniques to detect and evaluate the lane marks.

When straight lane marks are detected, the lane mark detection module 206 outputs a lane mark straight flag 228 indicating that the detected lane marks are straight. When straight lane marks are not detected, the lane mark detection module 206 outputs the lane mark straight flag 228 indicating that the lane marks are not straight.

The parameter determination module 208 receives the vehicle travel straight flag 225, and the lane mark straight flag 228, and the recorded data 214. The parameter determination module selects boresight alignment parameters 230 to be calibrated. For example, the parameter determination module 208 selects the boresight alignment parameters 230 based on a sensitivity analysis. The parameter determination module 208 then determines values 232 for the selected parameters using the recorded data 214 and for example, principal component analysis.

The calibration module 210 receives the parameter values 232. The calibration module 210 updates the calibrations associated with the lidar device by storing them, for example, in the data storage device 36 for use by other systems of the ADS 70.

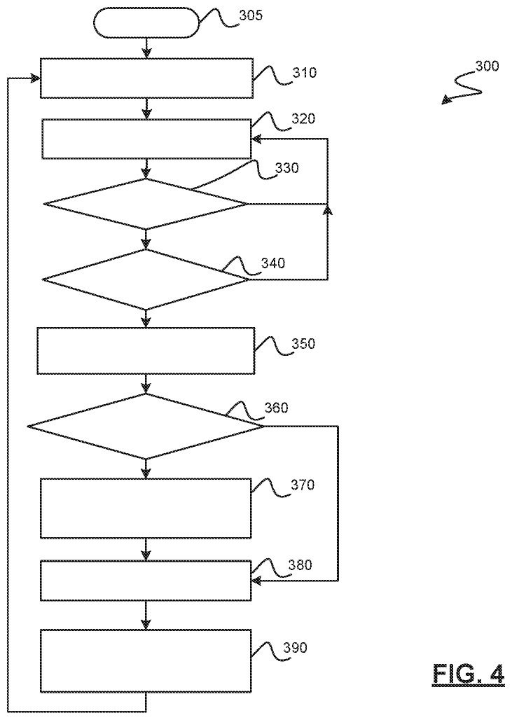

Referring now to FIGS. 4-10, and with continued reference to FIGS. 1-3, flowcharts illustrate various embodiments of a process 300 which may be embedded within a controller 34 in the control system 100 of FIG. 1 supporting the ADS 70 and the control module 200 of FIG. 3 in accordance with the present disclosure. As can be appreciated in light of the disclosure, the order of operation within the method is not limited to the sequential execution as illustrated in FIGS. 4-10 but may be performed in one or more varying orders as applicable and in accordance with the present disclosure. In various embodiments, the process 300 can be scheduled to run based on one or more predetermined events, and/or can run continuously during operation of the vehicle 10.

In various embodiments, FIG. 4 illustrates a method for dynamic lidar alignment. In one example, the method may begin at 305. Based on system level performance diagnosis or time interval of last dynamic calibration, the need to determine dynamic calibration is determined at 310. When there is a need for lidar alignment, lidar data, vehicle location data, and orientation data are continually recorded for a pre-determined time window when history or map data indicates on a straight road at 320.

Thereafter, it is determined whether the vehicle is driving straight for the pre-defined time window at 330. When it is not determined that the vehicle is driving straight for the pre-defined window at 330, the method 300 continues with recording lidar data, vehicle location data and orientation data for a pre-determined time window when history or map data indicates on a straight road at 320.

When it is determined that the vehicle is driving straight for the pre-defined window, then it is determined whether the straight lane mark is detected at 340. When it is determined that the straight line mark is not detected at 340, the method 300 continues with recording lidar data, the vehicle location data, and the orientation data for a pre-determined time window when history or map data indicates on a straight road at 320.

When it is determined that the straight line mark is detected at 340, the method continues with calibration of Lidar-INS boresight parameters by minimizing the lane mark shifts at different vehicle locations at 350. Thereafter, it is determined whether lane mark reference (Earth-fixed coordinates) exists for the given vehicle locations at 360. When lane mark references exist at 360, calibration of the Lidar-INS boresight parameters is performed by minimizing the differences between the references and the observed lane marks and the lane mark shifts for different vehicle locations at 370. Integration with multiple results is performed at 380 and the lane mark references are updated for the vehicle locations at 390. Thereafter, the method 300 continues with evaluating the need for re-calibration at 310.

When the lane mark references do not exist at 360, integration with multiple results is performed at 380 and the lane mark references are updated for the vehicle locations at 390. Thereafter, the method 300 continues with evaluating the need for re-calibration at 310.

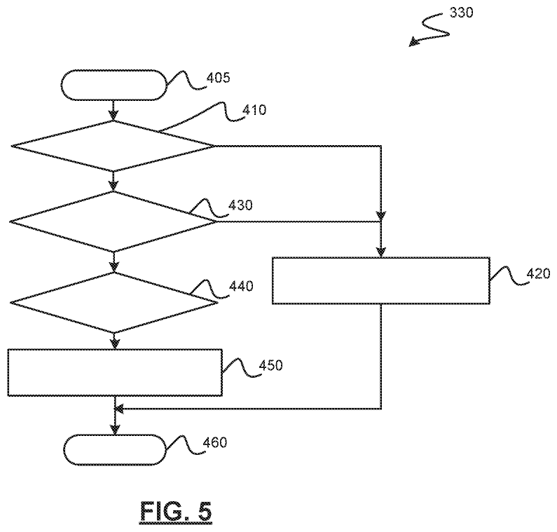

With reference now to FIG. 5, the method 330 for straight driving detection is shown in accordance with various embodiments. In one example, the method 330 may begin at 405. Thereafter, it is determined whether the lateral drift is small (e.g., below a threshold) at 410, for example by evaluating the expression ∫₀^{T}∫₀^{t}(α_{y}(τ)−r(τ)*vₓ(τ))dτ·dt<Th₁, where α_{y}: lateral acceleration; r: yaw rate; and vₓ: longitudinal speed.

When the lateral shift is determined to be small at 410, it is determined whether the vehicle GPS path is straight at 430 using, for example a regression check by evaluating the expression

$${max}_{i} \{ abs ( {y}_{i} - a - b * {x}_{i} ) \} < T {h}_{2} ,$$

where (xᵢ, yᵢ): vehicle GPS locations;

$$a = \overline{y} - b * \overline{x} ; b = {\sum }_{i} ( {x}_{i} - \overline{x} ) * ( {y}_{i} - \overline{y} ) / {\sum }_{i} {( {x}_{i} - \overline{x} )}^{2} ;$$

and x̅ and y̅: the average of xᵢ and yᵢ.

When the vehicle GPS path is straight at 430, it is determined whether the road is flat at 440 for example, by evaluating the expression max{zᵢ}−min{zᵢ}<Th₃, where zᵢ: vehicle GPS altitude.

When it is determined that the road is flat at 440, it is determined that the vehicle is driving straight at 450. Thereafter, the method 330 may end at 460.

However, when the lateral drift is determined to be large at 410, the GPS path is determined to be not straight at 430, or the road is not flat at 440, it is determined that the vehicle is not driving straight at 420. Thereafter, the method 330 may end at 460.

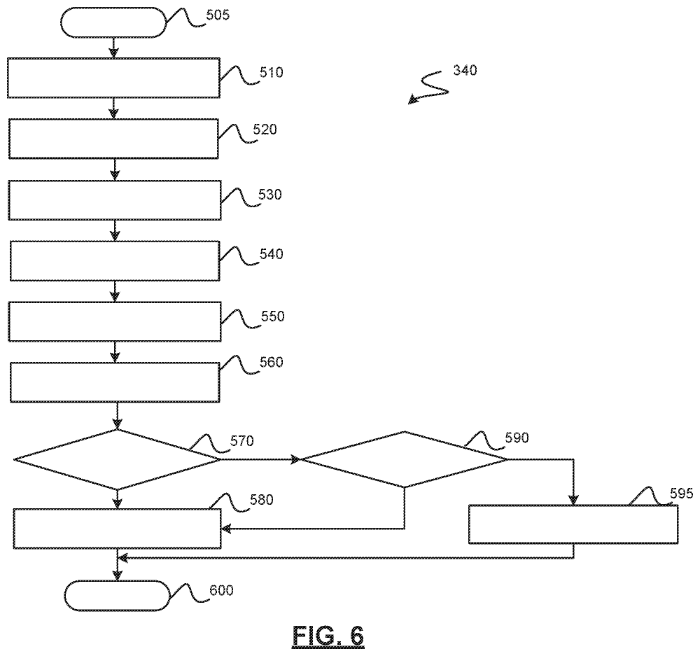

FIG. 6 illustrates the method 340 for lane mark detection in accordance with various embodiments. In one example, the method 340 may begin at 505. Lidar points are accumulated while the vehicle is driving straight ahead during the pre-defined time window at 510. The data points are translated to the world frame using the existing Lidar-INS boresight parameters and the vehicle INS values (positions and orientations) at 520. Ground points are extracted based on ground fitting and filtering at 530. Lane mark points are extracted based on intensity change detection and filtering at 540. Potential lane mark points are extracted based on spatial filtering (a>x>b, c>y>d) at 550 based on vehicle locations and the reference lane mark line information from maps, crowd sourcing, and history data. Noise points are removed by line model fitting at 560.

Thereafter, the straight line is evaluated by regression checking at 570. When the straight line is not confirmed at 570, it is determined that there is no lane mark at 580. Thereafter, the method may end a 600. When the straight line is confirmed at 570, enabling conditions are evaluated at 590, for example by evaluating the expressions the number of points >f; and length >h. When the conditions are met at 590, the lane mark is output at 595. When the conditions are not met at 590, no lane mark is output at 580 Thereafter, the method 340 may end at 600.

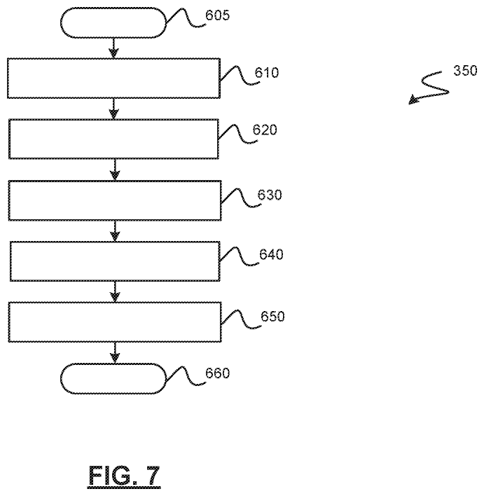

FIG. 7 illustrates the method 350 for calibration by minimizing lane mark shifts in accordance with various embodiments. In one example, the method 350 may begin at 605. The boresight alignment parameters to be calibrated are selected based on a sensitivity analysis at 610. The aggregated Lidar point distributions are rebalanced at near and far away longitudinal distances at 620. The second and third PCA components or the width and the height of the aggregated points for left and/or right lane marks respectively are computed at 630. The parameters are calibrated by minimizing the weighted summation of the above PCA components to the widths and heights for left and/or right lane marks until the results converge at 640. The calibrated parameter values are output along with the time, the final error from the cost function, and the number of points at 650. Thereafter, the method 350 may end at 660.

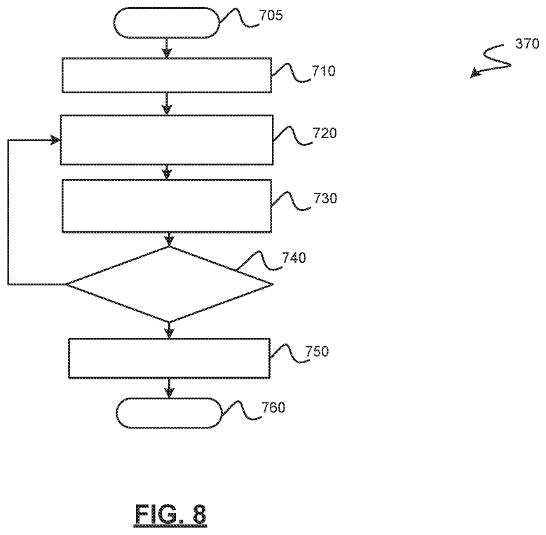

FIG. 8 illustrates the method 370 for calibration by minimizing lane mark shifts and the differences with the references in accordance with various embodiments. In one example, the method 370 may begin at 705. The lane mark points are generated from the reference lane mark line equations at 710. The parameters are calibrated by minimizing the differences with the reference lane mark earth-fixed coordinates by using the Lidar/Scan registration approaches at 720. The parameters are calibrated at 730 by minimizing the lane mark shifts at different vehicle locations as performed by the method 350.

Thereafter, it is determined whether the results converge, or the method has reached an iteration limit at 740. When the results have not converged and the time limit has not been reached at 740, the method 370 returns to calibrate the parameters by minimizing differences at 720.

When the results have converged or the time limit has been reached at 740, the calibrated parameters values are output along with the time, the error, and the number of data points at 750. Thereafter, the method 370 may end at 760.

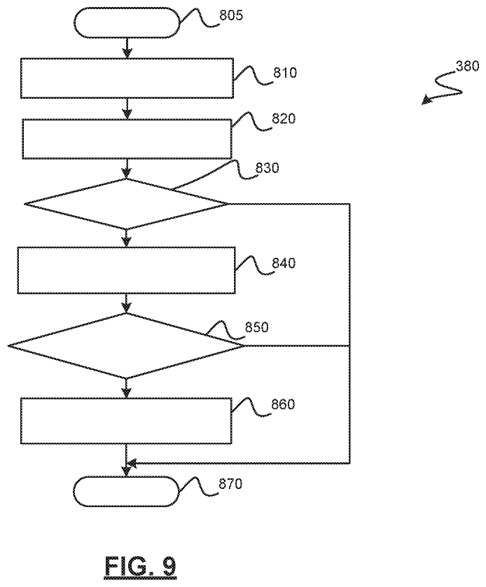

FIG. 9 illustrates the method 380 for integration with multiple results in accordance with various embodiments. In one example, the method 380 may begin at 805. The results that have expired (outside of the pre-defined time window) are removed from the saved result set at 810. The outliers from the saved multiple calibration results are removed at 820. The number of results is then evaluated at 830.

When the number of results is less than or equal to the k, the method 380 may end at 870. When the number of results is greater than k at 830, the mean and the variance of each parameter are computed at 840 from the results based on the weights from the time, the error, and the number of data points associated with each result. The variance is evaluated at 850. When the variance is less than the error for the parameter at 850, the parameter is updated with the mean at 860. And the method may end at 870. When the variance is greater than or equal to the error for the parameter at 850, the method 380 may end at 870.

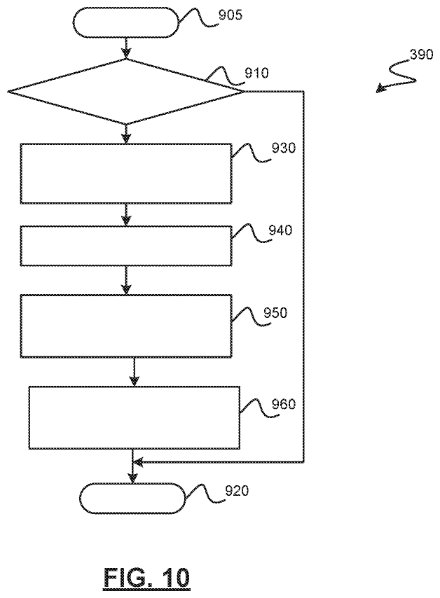

FIG. 10 illustrates the method 390 for updating the reference lane marks in accordance with various embodiments. In one example, the method 390 may begin at 905. It is determined whether the current result is added to the saved set at 910. When the current result is not added to the saved set at 910, the method 390 may end at 920.

When the current result is added to the saved set at 910, the earth-fixed coordinates are computed for the current set of lidar points using the updated calibration parameters at 930. The left and/or right lane mark line parameters (a*x+b*y+c*z=d) are identified by regression from the current point set at 940. The reference lane mark line parameters are updated at 950 from the above computed values based on the weight for the current data set from number of data points and the final error of the calibration cost function. The reference lane mark is saved by either the line parameters (a, b, c, d) or the earth-fixed coordinates of the two end points of the linear lane mark segment at 960. Thereafter, the method 390 may end at 920.

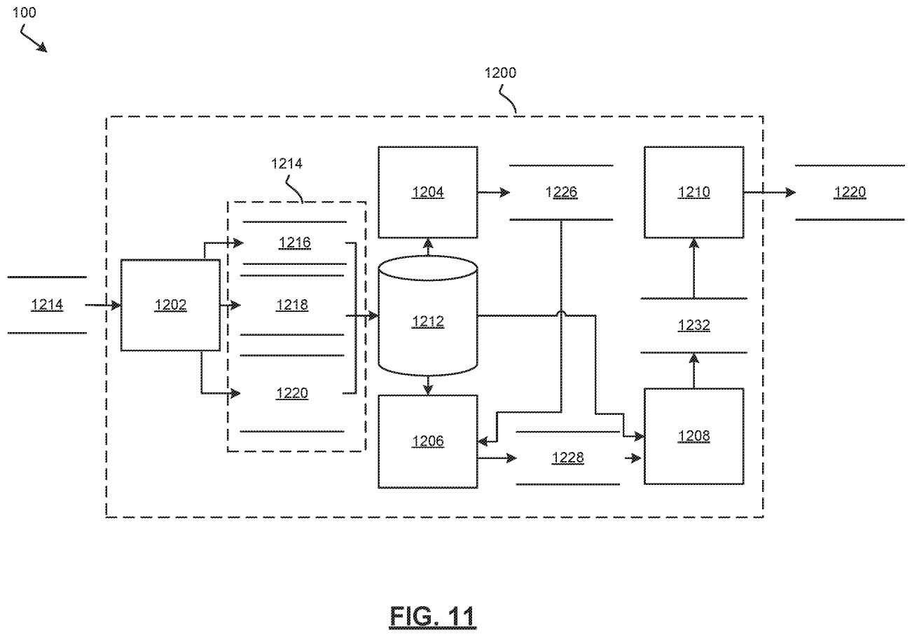

With reference now to FIG. 11 and with continued reference to FIGS. 1 and 2, FIG. 11 depicts another embodiment of a control module 1200 of the control system 100 which may be implemented by or incorporated into the controller 34, the processor 44, and/or the computer vision system 74. In various embodiments, the control module 1200 may be implemented as one or more sub-modules. As can be appreciated, the sub-modules shown and described may be combined and/or further partitioned in various embodiments. Data inputs to the control module 1200 may be received directly from the sensing devices 40a-40n, received from other modules (not shown) of the controller 34, and/or received from other controllers (not shown). In various embodiments, the control module 1200 includes a data collection module 1202, a vehicle cornering evaluation module 1204, an object detection module 1206, a parameter determination module 1208, a calibration module 1210, and a data datastore 1212.

In various embodiments, the data collection module 1202 receives as input recorded data 1214. In various embodiments, the recorded data 1214 includes lidar data 1216, IMU data 1218, and distance/speed data 1220 recorded over a predetermined of time. The data collection module 1202 resamples the recorded data based on the distance and speed and stores the recorded data 1214 in the data datastore 1212 for further processing.

The vehicle cornering evaluation module 1204 processes the recorded data 1214 to determine whether the vehicle 10 performed a cornering maneuver. For example, the vehicle cornering evaluation module 1204 evaluates the IMU data 1218 to determine when the vehicle 10 is performing a cornering maneuver.

When the vehicle 10 is determined to have performed a cornering maneuver, the vehicle cornering evaluation module 1204 outputs a vehicle cornering flag 1226 indicating that the vehicle 10 has performed a cornering maneuver. When the vehicle 10 is determined to not have performed a cornering maneuver, the vehicle cornering evaluation module 1204 outputs a vehicle cornering flag 1226 indicating that the vehicle 10 has performed a cornering maneuver.

The object detection module 1206 processes the recorded data 1214 to determine whether objects are detected within the environment of the vehicle 10. For example, the object detection module 1206 loops through each scan of the lidar data 1216 to determine if an object exists in more than one scan (e.g., a constant object).

When detected objects exist, the object detection module 1206 further processes the recorded data 1214 to determine whether data useful for calibration is available for at least one of the detected objects. When useful data is detected, the object detection module 1206 outputs a useful data detection flag 1228 indicating that useful data is available. When useful data is not detected, the object detection module 1206 outputs useful data detection flag 1228 indicating that useful data is not available.

The parameter determination module 1208 receives useful data detection flag 1228 and the recorded data 1214. The parameter determination module 1208 then determines values 1232 for calibration parameters using the determined useful data for the objects and for example, principal component analysis.

The calibration module 1210 receives the parameter values 1232. The calibration module 1210 updates the calibrations associated with the lidar device by storing them, for example, in the data storage device 36 for use by other systems of the ADS 70.

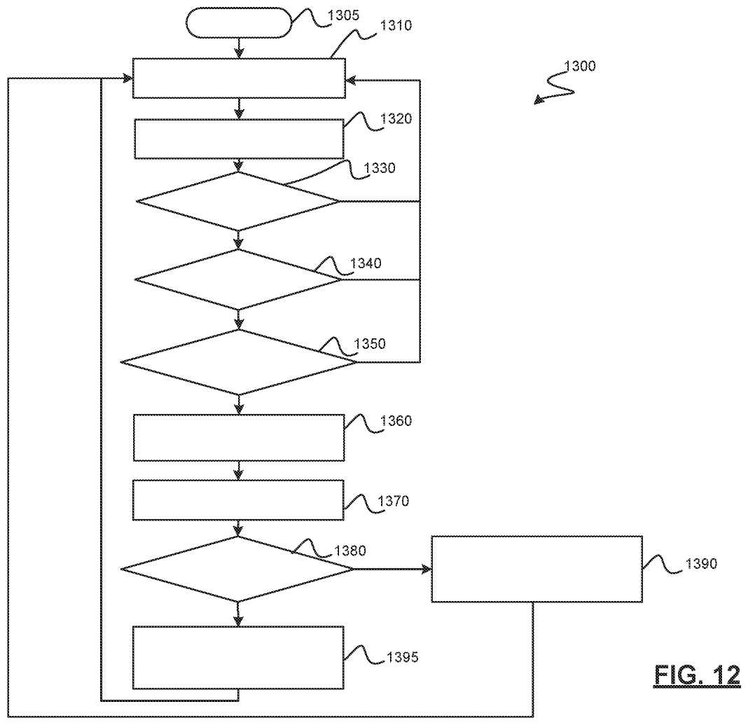

With reference now to FIGS. 12-21 and with continued reference to FIGS. 12, and 11, flowcharts illustrate various embodiments of a method 1300 which may be embedded within a controller 34 in the control system 100 of FIG. 1 supporting the ADS 70 and the control module 1200 of FIG. 11 in accordance with the present disclosure. As can be appreciated in light of the disclosure, the order of operation within the method is not limited to the sequential execution as illustrated in FIGS. 12-21 but may be performed in one or more varying orders as applicable and in accordance with the present disclosure. In various embodiments, the method 1300 can be scheduled to run based on one or more predetermined events, and/or can run continuously during operation of the vehicle 10.

In various embodiments, FIG. 12 illustrates a method 1300 for dynamic lidar alignment. In one example, the method 1300 may begin at 1305. Lidar data and IMU data are recorded using a cyclic buffer with a calibratable size for a calibratable period of time at 1310. The recorded data is then resampled by distance/speed at 1320.

Thereafter, the data is evaluated to determine if a cornering maneuver was performed at 1330. When it is determined that a cornering maneuver was not performed at 1330, the method 1300 continues with recording lidar data and IMU data at 1310.

When it is determined that a cornering maneuver was performed at 1330, it is determined whether objects useful for calibration are available at 1340. When it is determined that no objects for calibration are available at 1340, the method continues with recording new lidar data and IMU data at 1310.

When it is determined that objects useful for calibration are available at 1340, it is determined whether data useful for calibration corresponding to at least one of the objects is available at 1350. When it is determined that data useful for calibration is not available at 1350, the method 1300 continues with recording new lidar data and IMU data at 1310.

When it is determined that data useful for calibration is available at 1350, parameters (e.g., x, y coordinates, and roll, pitch, yaw angles) are computed using data relevant to calibrate at 1360 and z is computed at 1370.

Thereafter, it is determined whether all parameters (x, y, z, and roll, pitch, and yaw angles) are calibrated at 1380. When not all or none of the parameters are calibrated at 1380, partial calibration information is output and other calibration methods are invoked as appropriate at 1390.

When all parameters are calibrated at 1380, the calibration is completed by storing the determined parameters in the data storage device at 1395 and notifications may be sent indicating the parameters that were actually calibrated and results.

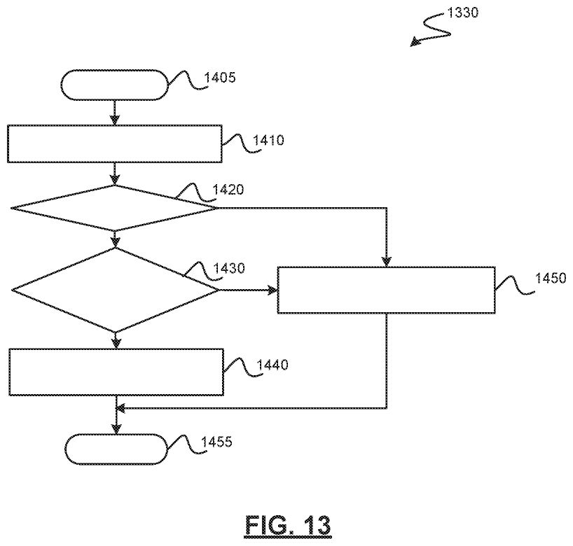

FIG. 13 illustrates the method 1330 for checking for a dynamic maneuver such as cornering in accordance with a first embodiment. In one example, the method 1330 may begin at 1405. The IMU data is read from the cyclic buffer at 1410. It is determined whether lateral acceleration is greater than A for time T₁ at 1420 (where A and T1 are calibratable thresholds). When the lateral acceleration is not greater than A for time T₁ at 1420, it is determined that the vehicle 10 is not cornering with rich enough data at 1450. Thereafter, the method 1330 may end at 1455. When the lateral acceleration is greater than A for time T₁, it is determined whether the yaw rate is greater than R for time T₂ and overlapping with T₁ at 1430 (where R and T₂ are calibratable thresholds).

When the yaw rate is not greater than R for time T₂ and overlapping with T₁ at 1430, the vehicle 10 is determined to not be with rich enough data at 1450 and the method 1330 may end at 1455. When the yaw rate is greater than R for time T₂ and overlapping with T₁ at 1430, the vehicle 10 is determined to be experiencing a cornering maneuver with potentially rich enough data at 1440. Thereafter, the method 1330 may end at 1455.

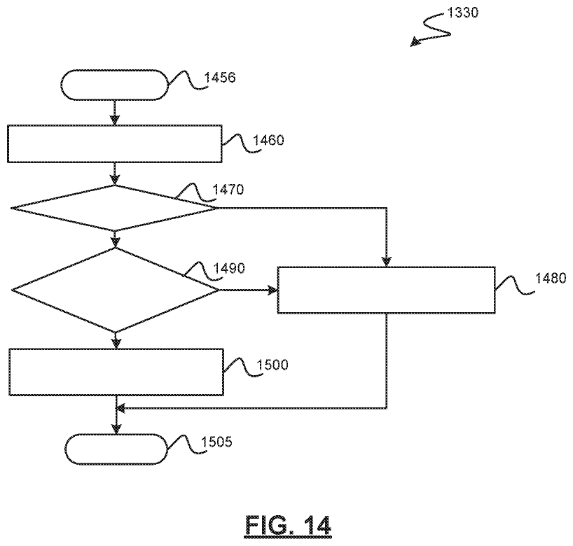

FIG. 14 illustrates the method 1330 for checking for a dynamic maneuver such as cornering in accordance with a second embodiment. In one example, the method 1330 may begin at 1456. The IMU data is read from the cyclic buffer at 1460. It is determined whether the change in (x, y) in world coordinate is greater than L for interval T₃ at 1470 (where L and T₃ are calibratable thresholds). When it is determined that the change in (x, y) in world coordinate is not greater than L for interval T₃ at 1470, the vehicle 10 is determined to be not cornering with rich enough data at 1480. Thereafter, the method 1330 may end at 1505.

When it is determined that the change in (x, y) in world coordinate is greater than L for interval T₃ at 1470, it is determined whether the yaw angle change is greater than Y in world coordinates for time T₄ and overlapping with T₃ at 1490 (where Y and T₄ are calibratable thresholds. When it is determined that the yaw angle change is greater than Y in world coordinates for time T₄ and overlapping with T₃ at 1490, the vehicle 10 is determined to be experiencing cornering maneuver with potentially rich enough data at 1500. Thereafter, the method 1330 may end at 1505. When it is determined that the yaw angle change is not greater than Y in world coordinates for time T₄ and overlapping with T₃ at 1490, the vehicle 10 is determined to be not cornering with rich enough data at 1480. Thereafter, the method 1330 may end at 1505.

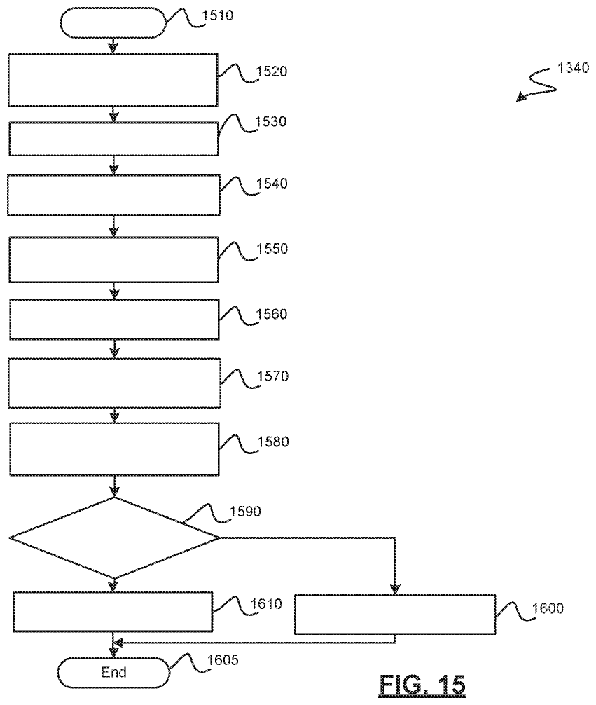

FIG. 15 illustrates the method 1340 for detecting objects in accordance with various embodiments. In one example, the method 1340 may begin at 1510. All lidar data is read and aggregated in world coordinates at 1520. Lidar data segmentation is performed on the lidar data at 1530. Low intensity points (e.g., <T₁) are filtered the data at 1540. Low (<T₂) and high (>T₃) range (distance) data is filtered out at 1550. Data position (mean shift clustering) and spatial dimension (ranges in (x, y, z)) are used to filter out at 1560. Potential objects with data points less than N₁ are filtered out at 1570. Objects are detected for each scan at 1580.

Thereafter, it is determined whether there is a considered object in at least N₂ (consecutive) scans at 1590. When there is not a considered object in at least N₂ (consecutive) scans at 1590, it is determined that no objects were detected at 1600. Thereafter, the method 1340 may end at 1605.

When there is a considered object in at least N₂ (consecutive) scans at 1590, it is determined that objects were detected at 1610. Thereafter, the method 1340 may end at 1605.

In various embodiments, T₁, T₂ T₃, N₁, N₂, range (x, y, z) are calibratable and specific to each object considered. Objects with true location known can also be obtained using HD maps, vehicle to vehicle communications, vehicle to infrastructure communications, etc.

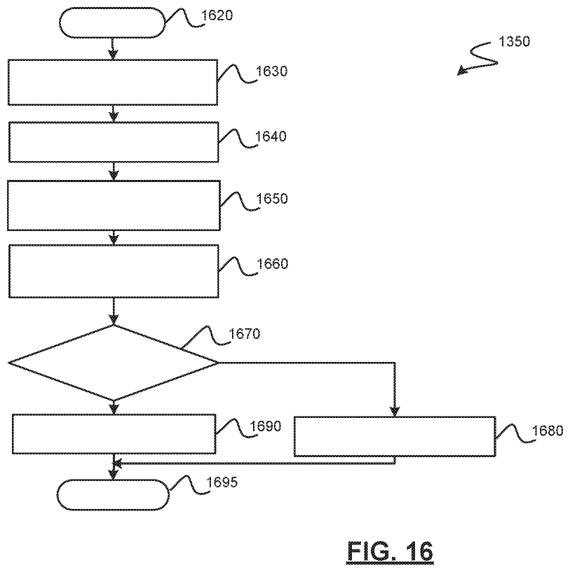

FIG. 16 illustrates the method 1350 for checking with data useful for calibration is available in accordance with various embodiments. In one example, the method 1350 may begin at 1620. All scans with particular objects and associated IMU data are read at 1630. It is determined whether scans exist for: (1) vehicle with different yaw angles with respect to the object, and (2) vehicle with large distance variation to object. The objects are labeled as: (0,0) if neither (1) nor (2) exist: no calibration capability, (1,0) if (1) exist but not (2): can be used to calibrate roll, pitch angles and (x, y), (0,1) if (2) exist but not (1): can be used to calibrate yaw angle, and (1,1) if both (1) and (2) exists: can be used to calibrate roll, pitch, yaw angles and (x, y).

Thereafter, a table is created at 1660 such that objects in each row correspond to label (i, j). It is determined whether not all objects are in row corresponding to (0,0) at 1670. When all objects are in row corresponding to (0, 0) at 1670, it is determined that no data is available at 1680. Thereafter, the method 1350 may end at 1695.

When all objects are not in row corresponding to (0, 0) at 1670, it is determined that data is available at 1690. Thereafter, the method 1350 may end at 1695.

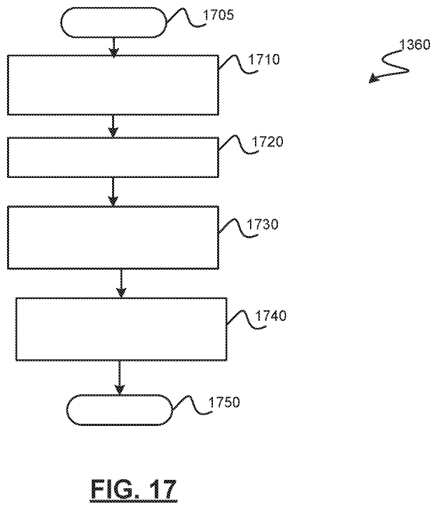

FIG. 17 illustrates the method 1360 of integrating calibration data from detected objects in accordance with various embodiments. In one example the method 1360 may begin at 1705. Calibration is performed using objects and data in row (1, 0) at 1710. In various embodiments, if none of the calibrations using the objects converged properly, the results will be skipped in the integration step 1740. Calibration is performed using objects and data in row (0, 1) at 1720. In various embodiments, if none of the calibrations using the objects converged properly, the results will be skipped in the integration step 1740. Calibration is performed using objects and data in row (1, 1) at 1730. In various embodiments, if none of the calibrations using the objects converged properly, the results will be skipped in the integration step 1740.

Thereafter, if at least one of the steps above had results that converged properly, the results from above steps are integrated at 1740 (e.g., take average of calibrated parameters). Thereafter, the method 1360 may end at 1750.

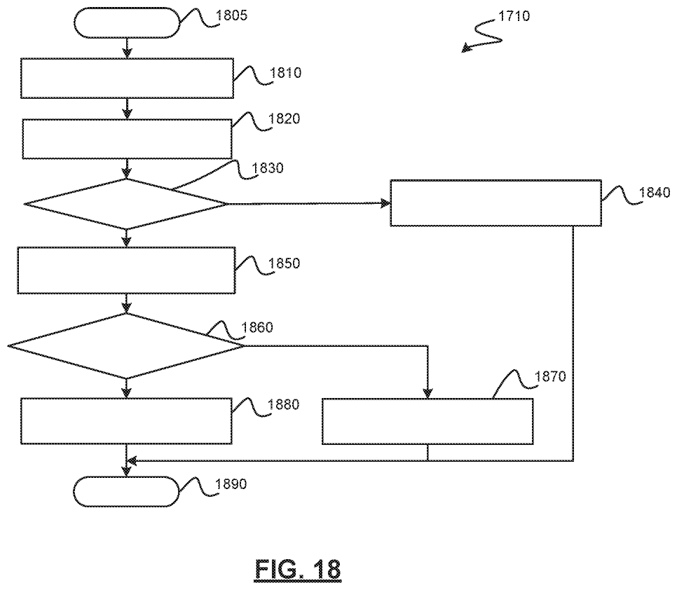

FIG. 18 illustrates the method 1710 of calibrating using the data in row (1, 0) in accordance with various embodiments. In one example the method 1710 may begin at 1805. For each object in row (1, 0) at 1810, the roll and pitch angles and (x, y) are calibrated using data (1) (e.g., by minimizing PCA components) at 1820; and the algorithms are evaluated to determine whether they converged properly at 1830. When the algorithms do not converge properly at 1830, other objects and data in the same row (category) are used at 1840. When the algorithms do converge properly at 1830, sensor alignment is completed for x, y, roll, and pitch angles at 1850.

Thereafter, it is determined whether at least one algorithm converged properly at 1860. When none of the algorithms converged properly at 1860, it is determined that calibration performed using (1, 0) failed at 1870. Thereafter, the method may end at 1890. When at least one algorithm did converge properly at 1860, the calibration results are integrated (e.g., take calibration average) at 1880. Thereafter, the method 1710 may end at 1890.

Alternatively, in various embodiments, for integration, algorithms for calibrating parameters can be run such that in each optimization step, each object in sequence is considered and the results of previous object is used as a starting point for the current object.

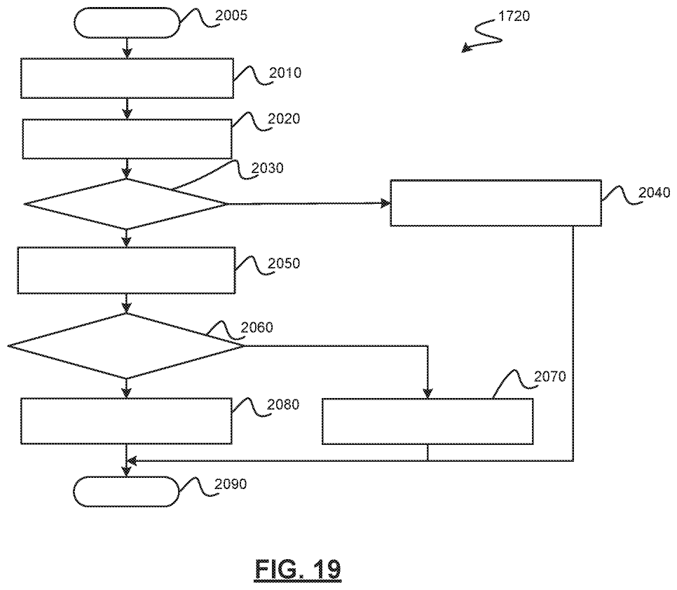

FIG. 19 illustrates the method 1720 of calibrating using the data in row (0, 1) in accordance with various embodiments. In one example the method may begin at 2005. For each object in row (0, 1) at 2010, the yaw angle using data (2) (e.g., by minimizing PCA components) at 2020; and the algorithms are evaluated to determine whether they converged properly at 2030. When the algorithms do not converge properly at 2030, other objects and data in the same row (category) are used at 2040. When the algorithms do converge properly at 2030, sensor alignment is completed the yaw angle at 2050.

Thereafter, it is determined whether at least one algorithm converged properly at 2060. When none of the algorithms converged properly at 2060, it is determined that calibration performed using (0, 1) failed at 2070. Thereafter, the method may end at 2090. When at least one algorithm did converge properly at 2060, the calibration results are integrated (e.g., take calibration average) at 2080. Thereafter, the method 1720 may end at 2090.

Alternatively, in various embodiments, for integration, algorithms for calibrating parameters can be run such that in each optimization step, each object in sequence is considered and the results of previous object is used as a starting point for the current object.

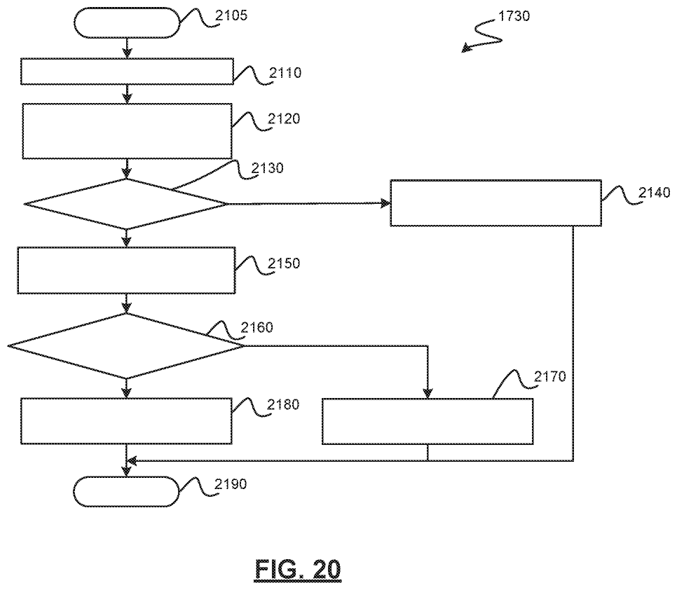

FIG. 20 illustrates the method 1730 of calibrating using the data in row (1, 1) in accordance with various embodiments. In one example the method 1730 may begin at 2105. For each object in row (1, 1) at 2110, the roll and pitch angles and (x, y) are calibrated using data (1) and (2) (e.g., by minimizing PCA components) at 2120; and the algorithms are evaluated to determine whether they converged properly at 2130. When the algorithms do not converge properly at 2130, other objects and data in the same row (category) are used at 2140. When the algorithms do converge properly at 2130, sensor alignment is completed for x, y, roll, and pitch angles at 2150.

Thereafter, it is determined whether at least one algorithm converged properly at 2160. When none of the algorithms converged properly at 2160, it is determined that calibration performed using (1, 1) failed at 2170. Thereafter, the method may end at 2190. When at least one algorithm did converge properly at 2160, the calibration results are integrated (e.g., take calibration average) at 2180. Thereafter, the method 1730 may end at 2190.

In various embodiments, depending on the object type, dimensions for PCA minimization may differ, e.g., if vehicle is driving straight and facing a sign, thickness dimension is ignored since it will not change due to calibration error. In various embodiments, alternatively, for integration, algorithms for calibrating parameters can be run such that in each optimization step, we consider each object in sequence and use the results of previous object as starting point for the current object.

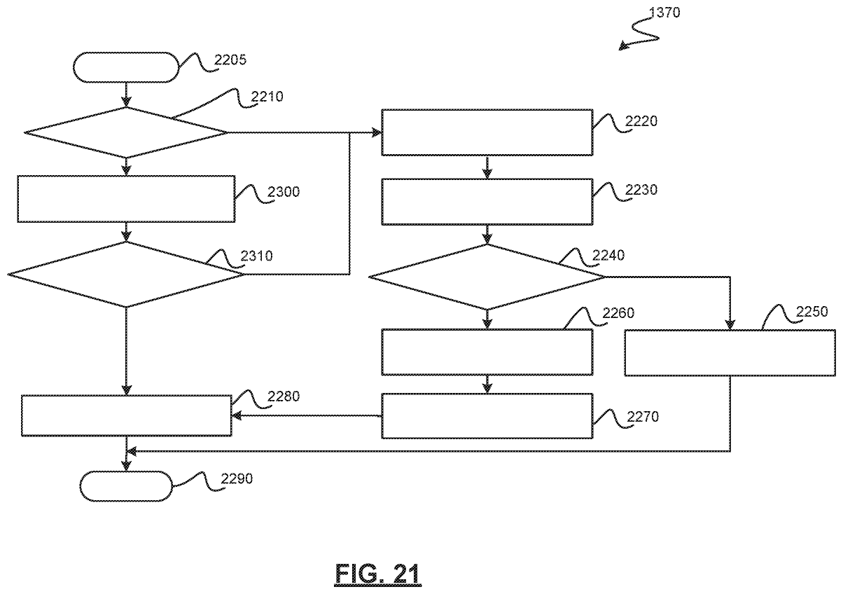

FIG. 21 illustrates the method of Z alignment 1370 in accordance with various embodiments. In one example, the method 1370 may begin at 2205.

It is determined whether information on objects with true location is available at 2210. When information on objects is not available at 2210, all lidar data is read and transformed to (1) IMU, (2) Lidar, or (3) World frame at 2220. Near field lidar points are collected with low z (i.e., data points with low vertical position values) at 2230. Thereafter, it is determined whether data is available with ground fitting at 2240.

When it is determined that data is available with ground fitting at 2240, mean of z is computed at 2260. Thereafter the calibrated z coordinate is computed in a respective coordinate frame at 2270 using:

t_{z_baseline}−t_{z_ins}−mean(z);

−mean(z)−t_{z_ins}; and

t_{z_baseline}−mean(z).

where tz_baseline is the initial guess of the Lidar z coordinate, tz_ins is the IMU sensor z coordinate, and mean(z) is the mean of z.

Thereafter, the sensor alignment for z is completed at 2280 and the method 1370 may end at 2290.

When it is determined that data is available with ground fitting at 2240, z is unable to be calibrated at 2250. Thereafter, the method may end at 2290.

If, at 2210, information on objects with true location is available, true target location information is used to calibrate for z, using by minimizing the difference between the true and the Lidar measured vertical coordinate values Δ_{z} at 2300. The algorithm is then checked to for convergence at 2310. When the algorithm converges at 2310, sensor alignment is completed for z at 2280 and the method may end at 2290. When the algorithm does not converge at 2310, the method 1370 continues with reading all lidar data 2220.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle having a lidar device, the method comprising:
recording, by a controller onboard the vehicle, lidar data from the lidar device while the vehicle is travelling on a straight road;
determining, by the controller, that the vehicle is travelling straight on the straight road;
detecting, by the controller, straight lane marks on the straight road;
computing, by the controller, lidar boresight parameters based on the straight lane marks;
calibrating, by the controller, the lidar device based on the lidar boresight parameters; and
controlling, by the controller, the vehicle based on data from the calibrated lidar device.

2. The method of claim 1, wherein the determining that the vehicle is travelling on the straight line is based on lateral drift of the vehicle.

3. The method of claim 1, wherein the determining that the vehicle is travelling on a straight line is based on global positioning data.

4. The method of claim 1, wherein the detecting straight lane marks is based on extracting ground points and lane mark points from the lidar data.

5. The method of claim 1, wherein the computing the lidar boresight parameters is based on principal component analysis.

6. The method of claim 5, wherein the computing the lidar boresight parameters comprises:
rebalancing, by the controller, lidar point distributions;
computing, by the controller second and third principal component parameters for the left and right marks; and
calibrating, by the controller, the boresight parameters.

7. The method of claim 1, further comprising:
determining, by the controller, that reference lane marks exist with earth coordinates; and
updating, by the controller, the lidar boresight parameters based on the reference lane marks.

8. The method of claim 7, further comprising:
computing, by the controller, the lidar boresight parameters based on different vehicle locations.

9. The method of claim 1, wherein the computing the lidar boresight parameters comprises performing integration with multiple lidar boresight parameters.

10. The method of claim 1, further comprising:
determining, by the controller, that the vehicle is travelling on a flat road; and wherein the detecting the straight lane marks is based on the vehicle travelling on the flat road.

11. A vehicle system of a vehicle, comprising:
a lidar device; and
a controller configured to, by a processor, record lidar data from the lidar device while the vehicle is travelling on a straight road, determine that the vehicle is travelling straight on the straight road, detect straight lane marks on the straight road, compute lidar boresight parameters based on the straight lane marks, calibrate the lidar device based on the lidar boresight parameters, and control the vehicle based on data from the calibrated lidar device.

12. The vehicle system of claim 11, wherein the controller is configured to determine that the vehicle is travelling on the straight line based on lateral drift of the vehicle.

13. The vehicle system of claim 11, wherein the controller is configured to determine that the vehicle is travelling on the straight line based on global positioning data.

14. The vehicle system of claim 11, wherein the controller is configured to detect straight lane marks based on extracting ground points and lane mark points from the lidar data.

15. The vehicle system of claim 11, wherein the controller is configured to compute the lidar boresight parameters based on principal component analysis.

16. The vehicle system of claim 15, wherein the controller is configured to compute the lidar boresight parameters by:
rebalancing, by the controller, lidar point distributions;
computing, by the controller second and third principal component parameters for the left and right marks; and
calibrating, by the controller, the boresight parameters.

17. The vehicle system of claim 11, wherein the controller is further configured to:
determine that reference lane marks exist with earth coordinates; and
update the lidar boresight parameters based on the reference lane marks.

18. The vehicle system of claim 17, wherein the controller is further configured to:
compute the lidar boresight parameters based on different vehicle locations.

19. The vehicle system of claim 11, wherein the controller is further configured to compute the lidar boresight parameters by performing integration with multiple lidar boresight parameters.

20. A method of controlling a vehicle having a lidar device and an inertial measurement unit (IMU), the method comprising:
determining, by a controller, that the vehicle is performing a cornering maneuver based on recorded lidar data and IMU data;
detecting, by the controller, objects in the lidar data;
determining, by the controller, useful data associated with the detected objects from the lidar data;
computing, by the controller, parameters based on the useful data;
calibrating, by the controller, the lidar device based on the parameters; and
controlling, by the controller, the vehicle based on data from the calibrated lidar device.
